(19) United States
(12) Patent Application Publication
(10) Pub. No.: US 2010/0070163 A1
(43) Pub. Date: Mar. 18, 2010

(54) PORTABLE NAVIGATION DEVICE AND APPLICATION THEREOF

(75) Inventors: Qi Liu, Shanghai City (CN); Steve Chang, Taipei Hsien (TW); Wen-Fong Chang, Taipei Hsien (TW)

Correspondence Address: BRIAN M. MCINNIS, 12th Floor, Ruttonjee House, 11 Duddell Street, Hong Kong, HK

(73) Assignee: INVENTEC APPLIANCES CORP., TAIPEI HSIEN (TW)

(21) Appl. No.: 12/492,121

(22) Filed: Jun. 25, 2009

(30) Foreign Application Priority Data
Sep. 17, 2008 (TW) 97135673

(51) Int. Cl. G01C 21/36

(52) U.S. Cl. 701/201

(57) ABSTRACT

A portable navigation device is disclosed. The portable navigation device includes a global positioning module, a user interface, a destination obtaining means, a status obtaining means and a route generating means. The global positioning module generates a current position of the portable navigation device based on a global positioning signal. The destination obtaining means obtains a destination from the user interface. The status obtaining means obtains a user status from the user interface. The route generating means generates a suggested route based on the current position, the destination and the user status.

### RELATED APPLICATIONS

This application claims priority to Taiwan Application Serial Number 97135673, filed Sep. 17, 2008, which is herein incorporated by reference.

### BACKGROUND

1. Field of Invention

The present invention relates to a navigation device and application thereof. More particularly, the present invention relates to a portable navigation device and application thereof.

2. Description of Related Art

With the advancement of technology, more and more people use portable navigation devices to do path planning when going out. However, the general operation of portable navigation devices is simple, and can only generate the fastest route as the suggested route based on the current position and the destination. Thus, the suggested route generated by portable navigation devices may not be able to meet the actual needs of users. For example, when users want to go out and play, they may need a suggested route with beautiful scenery along the way. Take another example, users may take different vehicles or even walk to their destinations, but the general operation of the existing navigation devices cannot generate suggested routes accordingly. Moreover, currently available navigation devices can only display pre-stored navigation maps without personal preferences.

Therefore, there is a need for a new portable navigation device and application thereof so as to plan different suggested routes based on the user's needs.

### SUMMARY

This invention discloses a portable navigation device and application thereof. Based on the user status, various suggested routes are provided In accordingly. Therefore, the suggested route is generated to fit the user's needs at that moment appropriately.

According to one embodiment of the present invention, a portable navigation device includes a global positioning module, a user interface, a destination obtaining means, a status obtaining means and a route generating means. The global positioning module generates a current position of the portable navigation device based on a global positioning signal. The destination obtaining means obtains a destination from the user interface. The status obtaining means obtains a user status from the user interface. The route generating means generates a suggested route based on the current position, the destination and the user status.

According to another embodiment of the present invention, a portable navigation method includes the following steps:

(1) A current position of the portable navigation device is generated based on a global positioning signal.

(2) A destination is obtained from a user interface.

(3) A user status is obtained from the user interface.

(4) A suggested route is generated based on the current position, the destination and the user status.

The features and advantages of this invention mentioned above will be apparent and further understood with the following illustration of exemplary embodiments and accompanying drawings.

### BRIEF DESCRIPTION OF THE DRAWINGS

The accompanying drawings are included to provide a further 1o understanding of the invention, and are incorporated in and constitute a part of this specification. The drawings illustrate embodiments of the invention and, together with the description, serve to explain the principles of the invention. In the drawings,

FIG. 1 illustrates a block diagram of a portable navigation device 100 according to one embodiment of this invention;

FIG. 2 illustrates one embodiment of rush module 160 in FIG. 1;

FIG. 3 illustrates one embodiment of amusement module 170 in FIG. 1;

FIG. 4 illustrates one embodiment of friend visiting module 180 in FIG. 1;

FIG. 5 illustrates one embodiment of driving module 190 in FIG. 1;

FIG. 6 illustrates one embodiment of navigation map display module 210 in FIG. 1;

FIG. 7 illustrates a flow chart of a portable navigation method 300 according to one embodiment of this invention;

FIG. 8 illustrates a flow chart of generating a suggested route according to one embodiment on rush status;

FIG. 9 illustrates a flow chart of generating a suggested route according to one embodiment on amusement status;

FIG. 10 illustrates a flow chart of generating a suggested route according to one embodiment on friend visiting status;

FIG. 11 illustrates a flow chart of generating a suggested route according to another embodiment on friend visiting status;

FIG. 12 illustrates a flow chart of generating a suggested route according to one embodiment on driving status;

FIG. 13 illustrates one embodiment of amending the navigation map; and

FIG. 14 illustrates another embodiment of amending the navigation map.

### DESCRIPTION OF THE PREFERRED EMBODIMENTS

Reference will now be made in detail to the embodiment of this invention, examples of which are illustrated in the accompanying drawings. Wherever possible, the same reference numbers are used in the drawings and the description to refer to the same or like parts.

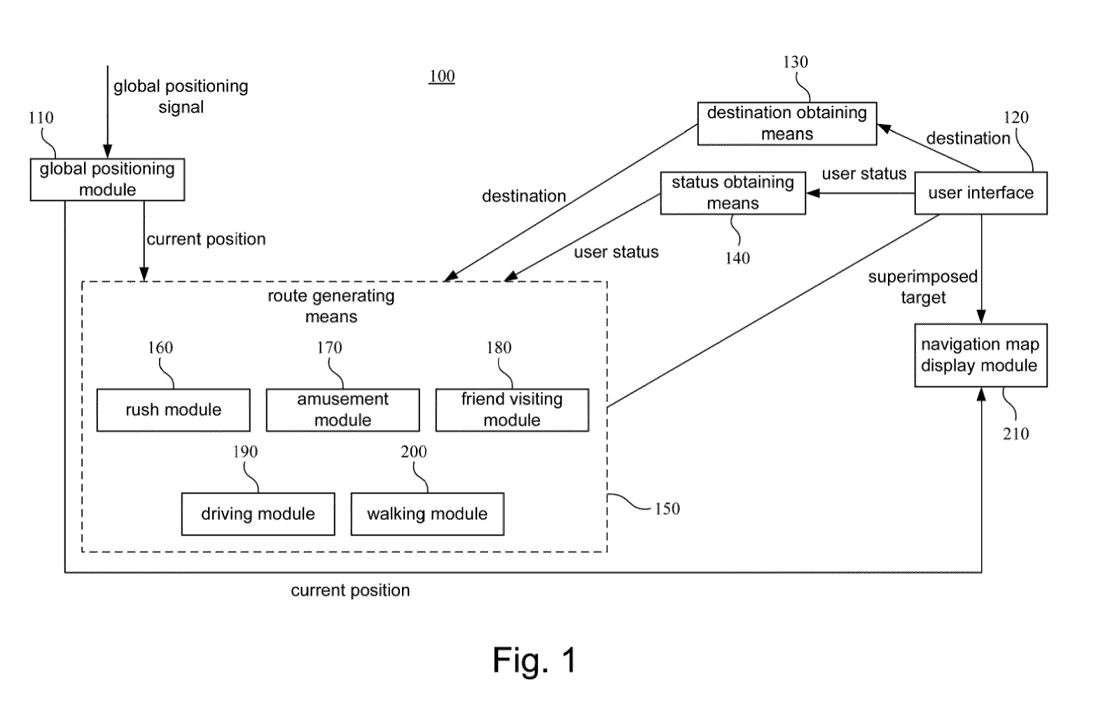

FIG. 1 illustrates a block diagram of a portable navigation device 100 according to one embodiment of this invention. The portable navigation device 100 may generate various suggested routes based on a user's needs. The portable navigation device 100 includes a global positioning module 110, a user interface 120, a destination obtaining means 130, a status obtaining means 140 and a route generating means 150. The global positioning module 110 generates a current position of the portable navigation device based on a global positioning signal. The destination obtaining means 130 obtains a destination from the user interface. The status obtaining means obtains a user status from the user interface 120. That is, the user may input a destination into the destination obtaining means 130 via the user interface 120. The status obtaining means 140 obtains a user status from the user interface 120. In other words, the user may input different user statuses according to various needs. The route generating means 150 generates a suggested route based on the current position, the destination and the user status. Thus, the user may enter different user statuses according to their needs, and may receive suggested routes that are needed.

Furthermore, the route generating means 150 may include various modules so as to process various user statuses. The route generating means 150 may include a rush module 160. The user may set user status as rush status when the user has to rush to the destination. When the user status is a rush status, the rush module 160 may generate a fastest route as the suggested route based on the current position and the destination. Thus, in the case of having to arrive the destination quickly, the user may set the user status as the rush status in order to obtain a fastest route.

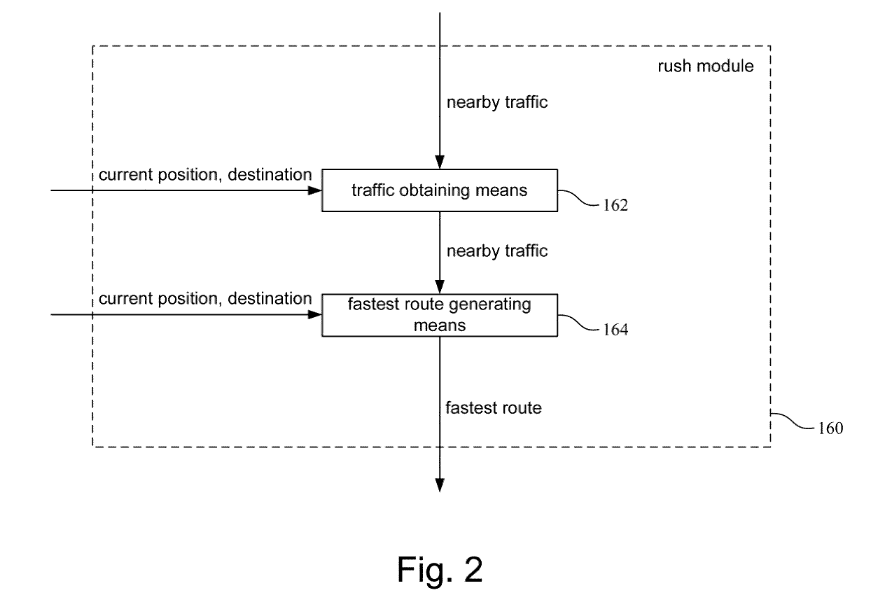

FIG. 2 illustrates one embodiment of rush module 160 in FIG. 1. The rush module 160 may further take the nearby traffic into consideration when generating a suggested route. The rush module 160 may include a traffic obtaining means 162 and a fastest route generating means 164. The traffic obtaining means 162 obtains a nearby traffic based on the current position and the destination. The traffic obtaining means 162 may obtain nearby traffic condition via the Radio Data System (RDS), Internet or other traffic condition obtaining means. The fastest route generating means 164 generates the fastest route as the suggested route based on the nearby traffic, the current position and the destination. Thus, after the rush module 160 takes the nearby traffic into consideration, the suggested route it generates may help the user arrive the destination more quickly.

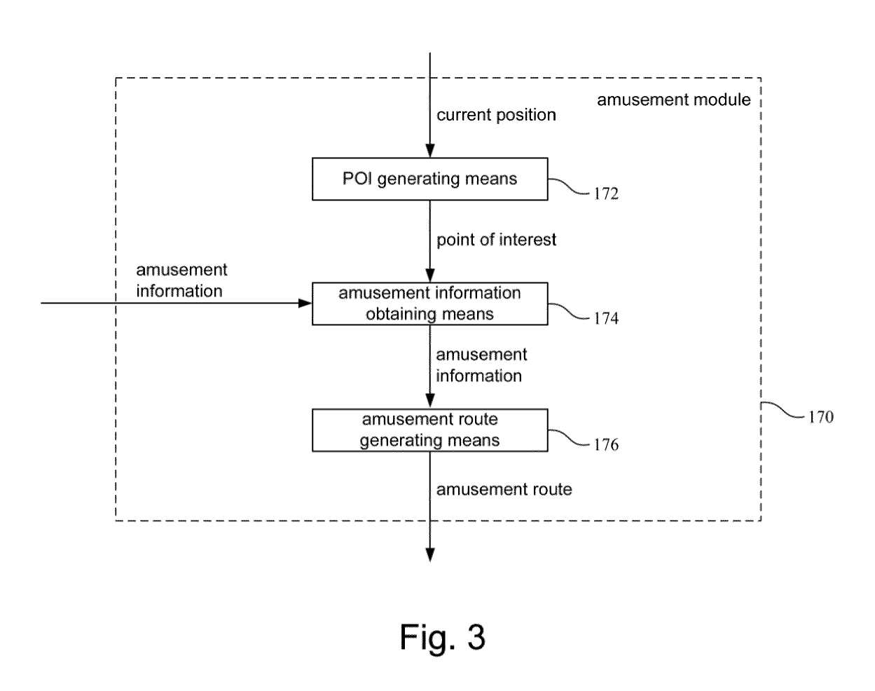

Refer to FIG. 1. The route generating means 150 may include an amusement module 170. The amusement module 170 generates an amusement route as the suggested route when the user status is amusement status. The user may set the user status as amusement status when going out for leisure or amusement activities. FIG. 3 illustrates one embodiment of amusement module 170 in FIG. 1. The amusement module 170 includes a POI (point of interest) generating means 172, an amusement information obtaining means 174, and an amusement route generating means 176. When the user status is an amusement status, the POI generating means 172 generates at Is least one point of interest based on the current position. The point of interest generated by the POI generating means 172 may be pre-stored in the portable navigation device 100 or obtained via any kind of network. The amusement information obtaining means 174 obtains amusement information based on the point of interest. The amusement information may be messages regarding upcoming performances, news about shopping discounts, or other information related to sightseeing, shopping or entertainment. The amusement route generating means 176 generates an amusement route as the suggested route based on the amusement information, the current position and the destination. Furthermore, the amusement route generating means 176 may refer to the time and place of the activities in amusement information and generate the amusement route based on the current position and the destination. Thus, when the user wants to have some form of amusement, the portable navigation device may generate an amusement route as the suggested route.

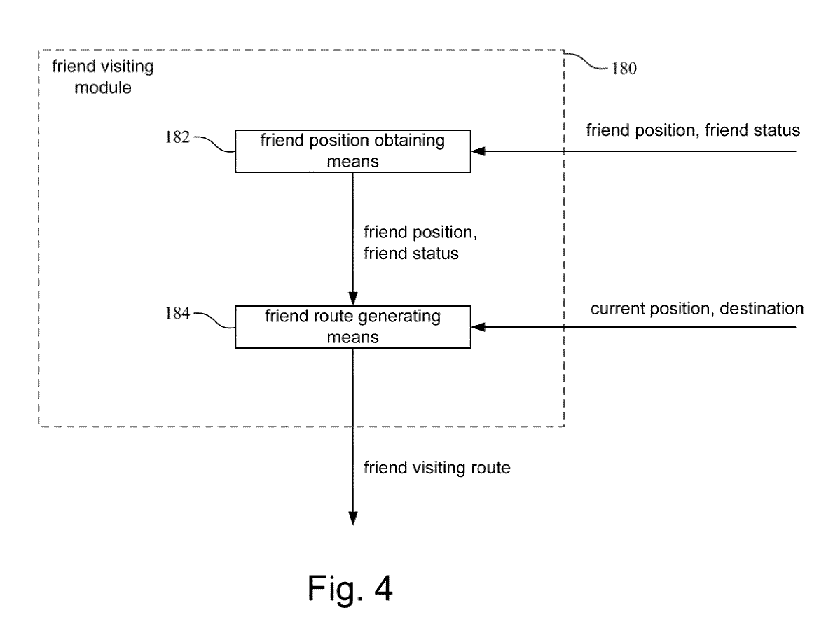

Refer to FIG. 1. The route generating means may include a friend visiting module 180. The friend visiting module 180 generates a friend visiting route as the suggested route when the user status is a friend visiting status. The user may set the user status as the friend visiting status when they want to visit a friend. FIG. 4 illustrates one embodiment of friend visiting module 180 in FIG. 1. The friend visiting module 180 includes a friend position obtaining means 182 and a friend route generating means 184. The friend position obtaining means 182 obtains at least one friend's position via address book software when the user status is a friend visiting status. The friend route generating means 184 generates a friend visiting route as the suggested route based on the friend's position, the current position and the destination. Thus, when the user wants to visit a friend, the portable navigation device may obtain the friend's position and generate a friend visiting route as the suggested route.

Additionally, the friend visiting module 180 may further take the friend status into consideration when generating a friend visiting route. Thus, the friend position obtaining means 182 may obtain a friend status on a friend's position via address book software. For example, the friend status may be busy, going out, available, or other statuses. Then, the friend route generating means 184 may further generate a friend visiting route as the suggested route based on the friend's position, the current position and the destination. Thus, the portable navigation device may generate friend visiting routes for friends available for visit.

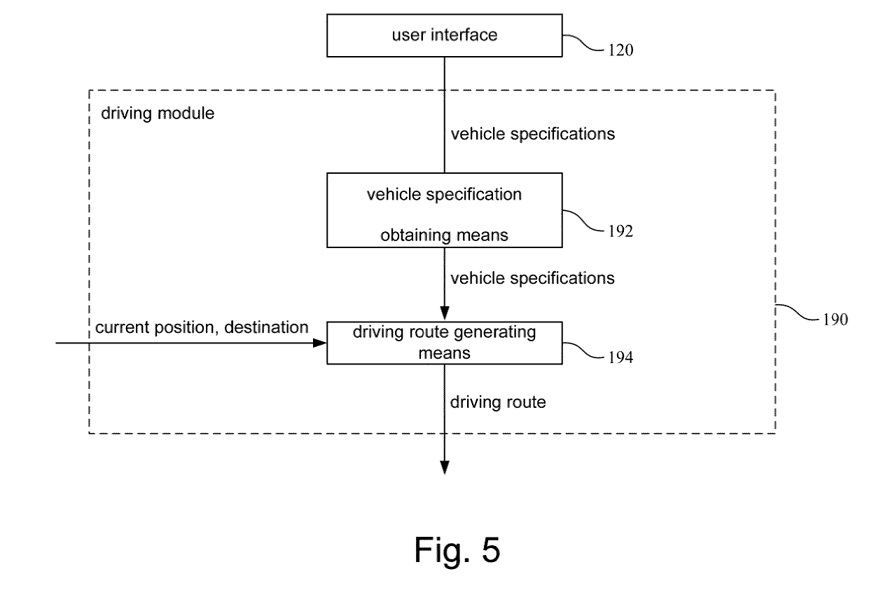

Refer to FIG. 1. The route generating means 150 may include a driving module 190. The driving module 190 generates a driving route as the suggested route when the user status is a driving status. The user may set the user status as driving status while they are driving. FIG. 5 illustrates one embodiment of driving module 190 in FIG. 1. The driving module 190 includes a vehicle specification obtaining means 192 and a driving route generating means 194. The vehicle specification obtaining means 192 obtains vehicle specifications from the user interface when the user status is a driving status. The vehicle specifications may be vehicle length, width, height, weight or other related parameters. The driving route generating means 194 generates a driving route as the suggested route based on the current position, the destination and the vehicle specifications. That is, when the user drives their vehicles on the suggested route generated by the driving route generating means 194, their vehicles can pass the width, height, weight and other limitations on the road. Thus, based on the specifications of the vehicle the user drives, the portable navigation device generates a suggested route suitable for the user.

Refer to FIG. 1. The route generating means 150 may include a walking module 200. The walking module 200 generates a walking route as the suggested route based on the current position, the destination and a predetermined walking parameter when the user status is a walking status. The user may set the user status as walking status while they are walking. The walking module 200 receives a predetermined walking parameter, and in turn generates a walking route involving pedestrian tunnels, bridges or other passages. Thus, the portable navigation device may generate a walking route appropriate for the user as the suggested route.

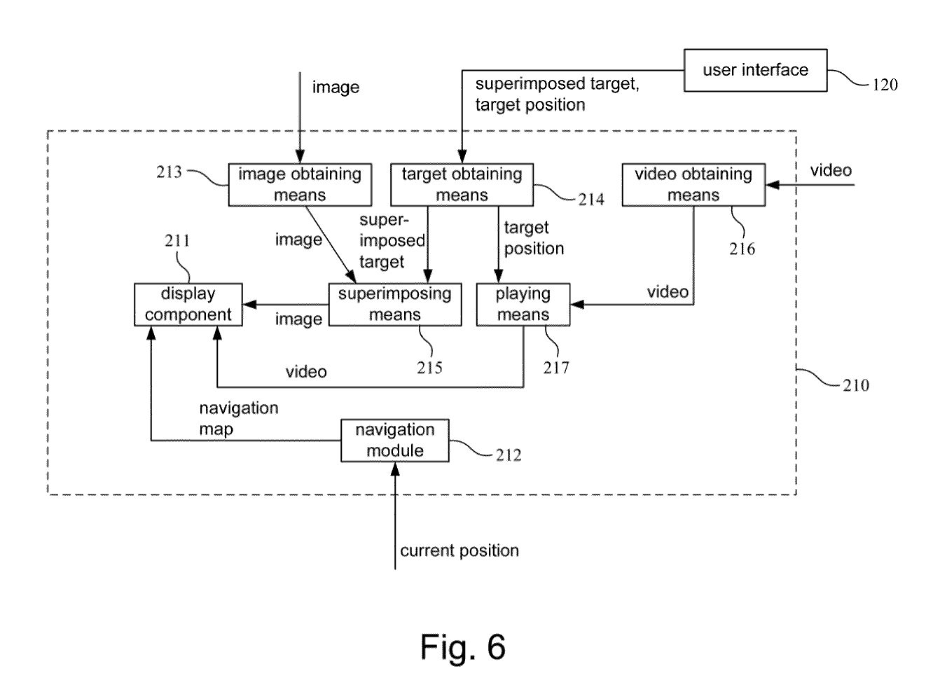

Refer to FIG. 1. The portable navigation device 100 may display a navigation map based on the current position, and may amend the displayed navigation map. Thus, the portable navigation device 100 may include a navigation map display module 210. The navigation map display module 210 may display a navigation map based on the current position, and may amend the navigation map and make the amended navigation map have personal preferences. FIG. 6 illustrates one embodiment of navigation map display module 210 in FIG. 1. The navigation map display module 210 may include a display component 211, a navigation module 212, an image obtaining means 213, a target obtaining means 214 and a superimposing means 215. The navigation module 212 obtains a navigation map for displaying on the display component based on the current position. The image obtaining means 213 obtains an image. The target obtaining means 214 obtains a superimposed target on the navigation map from the user interface 120. The superimposed target may be a location, background, or other objects displayed on the navigation map. The superimposing means 215 superimposes the image on the superimposed target. Thus, the portable navigation device 100 may display a map with the user's personal preferences.

Additionally, the navigation map display module 210 may display user-defined videos on the navigation map. Thus, the navigation map display module 210 may include a video obtaining means 216 and a playing means 217. The video obtaining means 216 obtains a video. The target obtaining means 214 obtains a superimposed target on the navigation map from the user interface. The playing means 217 plays the video on the superimposed target. Thus, the video selected by the user may be played at the user-selected location on the navigation map.

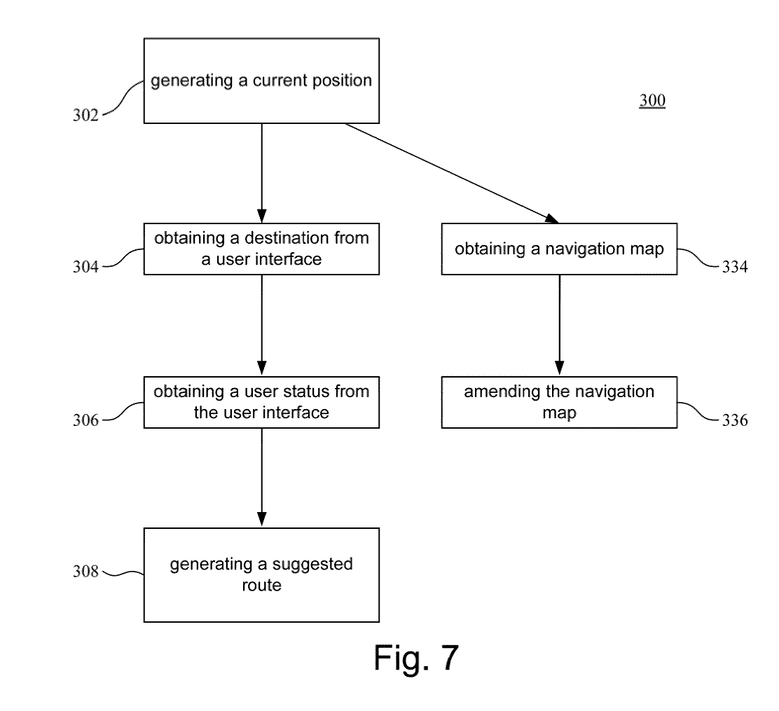

FIG. 7 illustrates a flow chart of a portable navigation method 300 according to one embodiment of this invention. The portable navigation method 300 may generate different suggested routes based on the user's needs. The portable navigation method 300 includes the following steps:

(1) Generate a current position based on a global positioning signal (step 302).

(2) Obtain a destination from a user interface (step 304).

(3) Obtain a user status from the user interface (step 306).

(4) Generate a suggested route based on the current position, the destination and the user status (step 308).

Thus, the portable navigation method may generate suggested routes which match the user's needs based on different user status the user inputs.

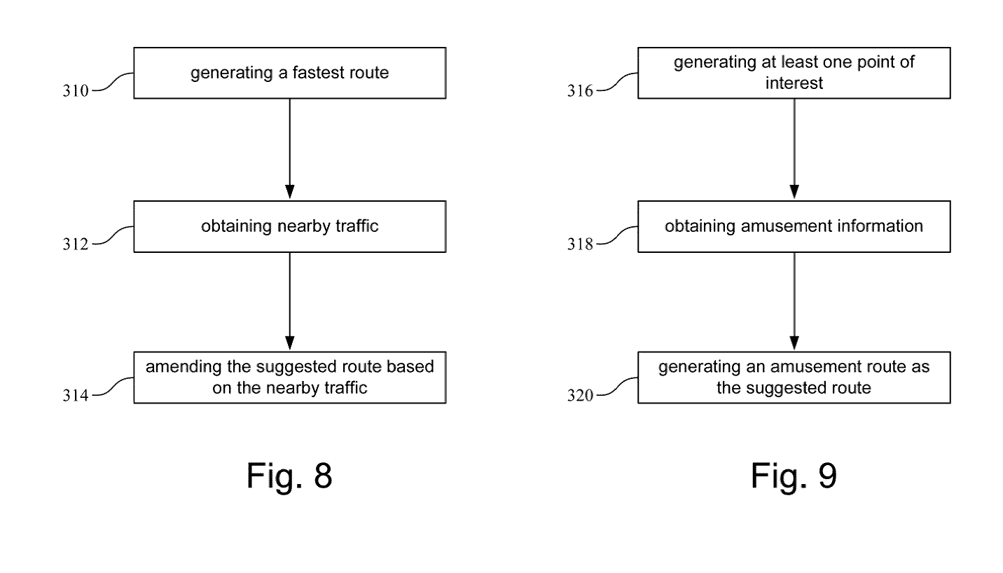

Furthermore, the portable navigation method may include several steps to generate a suggested route (step 308). FIG. 8 illustrates a flow chart of generating a suggested route according to one embodiment on rush status. When the user has to arrive the destination quickly, they may set the user status as rush status. Thus, the step of generating a suggested route may include:

(4.1.1) When the user status is a rush status, generate a fastest route as the suggested route based on the current position and the destination (step 310).

Thus, the suggested route generated by the portable navigation method may let the user arrive the destination as soon as possible.

Additionally, when the user is on a rush status, the method may amend the suggested route based on the nearby traffic. Thus, the step of generating a suggested route may include:

(4.1.2) Obtain nearby traffic based on the current position and the destination (step 312).

(4.1.3) Amend the suggested route based on the nearby traffic (step 314).

The nearby traffic condition may be obtained via the Radio Data System (RDS), Internet or other ways that can obtain traffic condition (step 312). Thus, the portable navigation method may generate the fastest route at that moment as the suggested route based on the nearby traffic condition.

The portable navigation method may include steps of generating a suggested route when the user status is amusement status. The user may set the user status as amusement status when they want to go out and play. FIG. 9 illustrates a flow chart of generating a suggested route according to one embodiment on amusement status. The step of generating a suggested route may include:

(4.2.1) Generate at least one point of interest based on the current position when the user status is an amusement status (step 316).

(4.2.2) Obtain amusement information based on the point of interest (step 318).

(4.2.3) Generate an amusement route as the suggested route based on the amusement information (step 320).

The point of interest may be obtained via the Internet or from a pre-stored database (step 316). The amusement information obtained at step 318 may be messages regarding any performances, news about shopping discounts, or other information related to sightseeing, shopping or entertainment. At step 320, the amusement route may be generated based on the current position and the destination and by referring to the time and place of the activities in amusement information. Thus, when the user wants to go out and play, the portable navigation method may generate an amusement route as the suggested route.

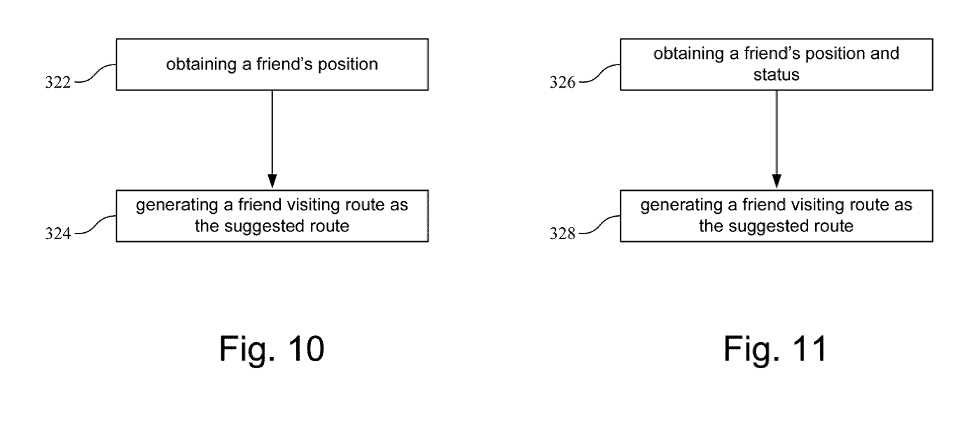

The portable navigation method may include the step of generating a suggested route when the user status is a friend visiting status. The user may set the user status as the friend visiting status when they want to visit a friend. FIG. 10 illustrates a flow chart of generating a suggested route according to one embodiment on friend visiting status. The step of generating a suggested route may include:

(4.3.1) Obtain at least one friend's position via address book software when the user status is a friend visiting status (step 322).

(4.3.2) Generate a friend visiting route as the suggested route based on the friend's position, the current position and the destination (step 324).

Thus, the portable navigation method may generate a friend visiting route as the suggested route.

Additionally, when the user is on a friend visiting status, the portable navigation method may take friend status into consideration to generate a suggested route. That is, only the friends available for visit are considered when the suggested route is generated. FIG. 11 illustrates a flow chart of generating a suggested route according to another embodiment on friend visiting status. The step of generating a suggested route may include:

(4.4.1) Obtain at least one friend's position and a friend status at the friend's position via address book software when the user status is a friend visiting status (step 326).

(4.4.2) Generate a friend visiting route as the suggested route based on the friend's position, the current position and the destination (step 328).

Thus, the portable navigation method may take friends available for visit into consideration based on friend status and generate a suggested route.

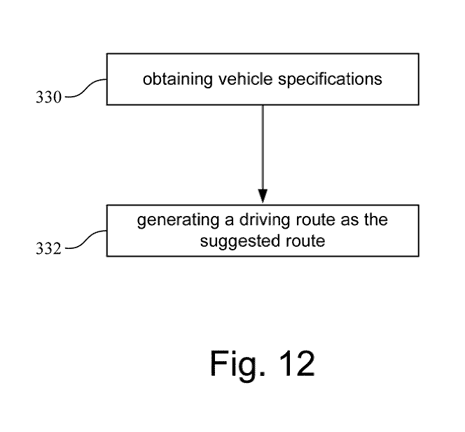

The portable navigation method may include the step of generating a suggested route when the user status is a driving status. The user may set the user status as driving status while driving. FIG. 12 illustrates a flow chart of generating a suggested route according to one embodiment on driving status. The step of generating a suggested route may include:

(4.5.1) Obtain vehicle specifications from the user interface when the user status is a driving status (step 330).

(4.5.2) Generate a driving route as the suggested route based on the current position, the destination and the vehicle specifications (step 332).

In practice, the vehicle specifications obtained at step 330 may be vehicle length, width, height, weight or other related parameters. That is, when the user drives their vehicles on the suggested route, their vehicles can pass the width, height, weight and other limitations on the road. Thus, based on the specifications of the vehicle the user drives, a suggested route suitable for the user is generated.

The portable navigation method may include a step of generating a suggested route when the user status is a walking status. The user may set the user status as walking status while they are walking. Further, when the user status is a walking status, a walking route is generated as the suggested route based on the current position, the destination and a predetermined walking parameter. After a predetermined walking parameter is received, the portable navigation method may generate a walking route involving pedestrian tunnels, bridges or other passages. Thus, the portable navigation method may generate a walking route appropriate for the user as the suggested route.

Refer to FIG. 7. The portable navigation method 300 may obtain a navigation map after generating a current position (step 302), and amend the obtained navigation map to generate a user-defined navigation map. Thus, the portable navigation method 300 may include:

(1.1) Obtain a navigation map based on the current position (step 334).

(1.2) Amend the navigation map (step 336).

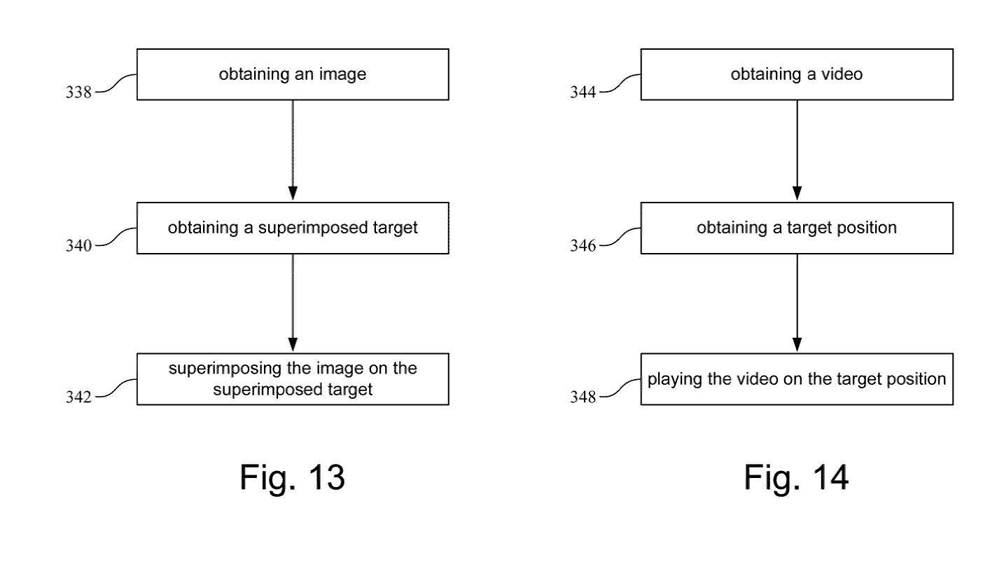

The portable navigation method may have many ways to amend the navigation map (step 336). FIG. 13 illustrates one embodiment of amending the navigation map. The step of amending the navigation map may include:

(1.2.1) Obtain an image (step 338).

(1.2.2) Obtain a superimposed target on the navigation map from the user interface (step 340).

(1.2.3) Superimpose the image on the superimposed target (step 342).

Thus, the user may put user-defined images on the navigation map and make the navigation map have personal preferences.

Additionally, the user may put user-defined videos on the navigation map. FIG. 14 illustrates another embodiment of amending the navigation map. The step of amending the navigation map may include:

(1.2.a) Obtain a video (step 344).

(1.2.b) Obtain a target position on the navigation map from the user interface (step 346).

(1.2.c) Play the obtained video on the target position (step 348).

Thus, the user may play user-defined videos at the selected position on the navigation map, and make the navigation map have personal preferences.

It will be apparent to those skilled in the art that various modifications and variations can be made to the structure of the embodiment without departing from the scope or spirit of the invention. In view of the foregoing, it is intended that the embodiment cover modifications and variations of this invention provided they fall within the scope of the following claims and their equivalents.

What is claimed is:

1. A portable navigation device comprising:
a global positioning module for generating a current position based on a global positioning signal;
a user interface;
means for obtaining a destination from the user interface;
means for obtaining a user status from the user interface; and
means for generating a suggested route based on the current position, the destination and the user status.

2. The portable navigation device of claim 1, wherein the means for generating a suggested route comprises:
a rush module for generating a fastest route as the suggested route based on the current position and the destination when the user status is a rush status.

3. The portable navigation device of claim 2, wherein the means for generating a fastest route comprises:
means for obtaining a nearby traffic based on the current position and the destination; and
means for generating the fastest route as the suggested route based on the nearby traffic, the current position and the destination.

4. The portable navigation device of claim 1, wherein the means for generating a suggested route comprises:
means for generating at least one point of interest based on the current position when the user status is an amusement status;
means for obtaining an amusement information based on the point of interest; and
means for generating an amusement route as the suggested route based on the amusement information, the current position and the destination.

5. The portable navigation device of claim 1, wherein the means for generating a suggested route comprises:
means for obtaining at least one friend's position via address book software when the user status is a friend visiting status; and
means for generating a friend visiting route as the suggested route based on the friend's position, the current position and the destination.

6. The portable navigation device of claim 1, wherein the means for generating a suggested route comprises:
means for obtaining at least one friend's position and a friend status at the friend's position via address book software when the user status is a friend visiting status; and
means for generating a friend visiting route as the suggested route based on the friend's position, the friend status, the current position and the destination.

7. The portable navigation device of claim 1, wherein the means for generating a suggested route comprises:
means for obtaining vehicle specifications from the user interface when the user status is a driving status; and
means for generating a driving route as the suggested route based on the current position, the destination and the vehicle specifications.

8. The portable navigation device of claim 1, wherein the means for generating a suggested route comprises:
a walking module for generating a walking route as the suggested route based on the current position, the destination and a predetermined walking parameter when the user status is a walking status.

9. The portable navigation device of claim 1, further comprising:
a display component;
a navigation module for obtaining a navigation map for displaying on the display component based on the current position;
means for obtaining an image;
means for obtaining a superimposed target on the navigation map from the user interface; and
means for superimposing the image on the superimposed target.

10. The portable navigation device of claim 1, further comprising:
a display component;
a navigation module for obtaining a navigation map for displaying on the display component based on the current position;
means for obtaining a video;
means for obtaining a superimposed target on the navigation map from the user interface; and
means for playing the video on the superimposed target.

11. A portable navigation method comprising:
generating a current position of the portable navigation device based on a global positioning signal;
obtaining a destination from a user interface;
obtaining a user status from the user interface; and
generating a suggested route based on the current position, the destination and the user status.

12. The portable navigation method of claim 11, wherein the step of generating a suggested route comprises:
generating a fastest route as the suggested route based on the current position and the destination when the user status is a rush status.

13. The portable navigation method of claim 12, further comprising:
obtaining a nearby traffic based on the current position and the destination; and
amending the suggested route based on the nearby traffic.

14. The portable navigation method of claim 11, wherein the step of generating a suggested route comprises:
generating at least one point of interest based on the current position when the user status is an amusement status;
obtaining an amusement information based on the point of interest; and
generating an amusement route as the suggested route based on the amusement information.

15. The portable navigation method of claim 11, wherein the step of generating a suggested route comprises:
obtaining at least one friend's position via address book software when the user status is a friend visiting status; and
generating a friend visiting route as the suggested route based on the friend's position, the current position and the destination.

16. The portable navigation method of claim 11, wherein the step of generating a suggested route comprises:
obtaining at least one friend's position and a friend status at the friend's position via address book software when the user status is a friend visiting status; and
generating a friend visiting route as the suggested route based on the friend's position, the friend status, the current position and the destination.

17. The portable navigation method of claim 11, wherein the step of generating a suggested route comprises:
obtaining vehicle specifications from the user interface when the user status is a driving status; and
generating a driving route as the suggested route based on the current position, the destination and the vehicle specifications.

18. The portable navigation method of claim 11, wherein the step of generating a suggested route comprises:
generating a walking route as the suggested route based on the current position, the destination and a predetermined walking parameter when the user status is a walking status.

19. The portable navigation method of claim 11, further comprising:
obtaining a navigation map based on the current position;
obtaining an image;
obtaining a superimposed target on the navigation map from the user interface; and
superimposing the image on the superimposed target.

20. The portable navigation method of claim 11, further comprising:
obtaining a navigation map based on the current position;
obtaining a video;
obtaining a target position on the navigation map from the user interface; and
playing the video on the target position.
